(19) United States
(12) Patent Application Publication
(10) Pub. No.: US 2015/0296305 A1
(43) Pub. Date: Oct. 15, 2015

(54) OPTIMIZED BACK PLATE USED IN ACOUSTIC DEVICES

(71) Applicant: Knowles Electronics, LLC, Itasca, IL (US)

(72) Inventors: Ning Shao, Bartlett, IL (US); Eric J. Lautenschlager, Geneva, IL (US)

(21) Appl. No.: 14/669,655

(22) Filed: Mar. 26, 2015

Related U.S. Application Data
(60) Provisional application No. 61/977,910, filed on Apr. 10, 2014.

(51) Int. Cl. H04R 23/00

(52) U.S. Cl. CPC H04R 23/00; H04R 2201/003

(57) ABSTRACT

An electrode apparatus of a back plate that is used in a microelectromechanical system (MEMS) microphone is disposed in spaced proximity to a diaphragm. The electrode apparatus includes a support layer and a conductive layer that is arranged in proximity to the support layer. At least one of a shape, a dimension, or a sizing of the conductive layer is matched to one or more of a sensitivity of the diaphragm, an operation of the diaphragm, or a movement of the diaphragm.

### CROSS REFERENCE TO RELATED APPLICATION

This application which claims the benefit of U.S. Provisional Application No. 61/977,910 entitled “Optimized Back Plate Used In Acoustic Devices” filed Apr. 10, 2014, the contents of which are incorporated herein by reference in its entirety.

### TECHNICAL FIELD

This application relates to acoustic devices and, more specifically, to the configurations of back plates of these devices.

### BACKGROUND OF THE INVENTION

Various types of acoustic devices have been used over the years. One example of an acoustic device is a microphone. Generally speaking, a microphone converts sound waves into an electrical signal. Microphones sometimes include multiple components that include micro-electro-mechanical systems (MEMS) and integrated circuits (e.g., application specific integrated circuits (ASICs)). A MEMS die typically has disposed on it a diaphragm and a back plate. Changes in sound energy move the diaphragm, which changes the capacitance involving the back plate thereby creating an electrical signal. The MEMS die is typically disposed on a base or substrate along with the ASIC and then both are enclosed by a lid or cover.

In MEMS motors having a back plate and a diaphragm, the back plate has an electrode that covers some area. It is in and with this electrode area that the signal from the diaphragm is picked-up or sensed. In previous microphones, a non-optimized and circular design was typically used for the electrode in order to sense the signal. However, this non-optimized design resulted in wasted space (e.g., it included areas where no signal was ever sensed) or had areas where signal was present, but no electrode existed to sense the signal.

The non-optimized design of previous back plate electrodes has limited the performance of acoustic devices such as microphones that utilize these electrodes. This has created some user dissatisfaction with these previous approaches.

### BRIEF DESCRIPTION OF THE DRAWINGS

For a more complete understanding of the disclosure, reference should be made to the following detailed description and accompanying drawings wherein:

FIG. 1A comprises a perspective view of portions of a microphone according to various embodiments of the present invention;

FIG. 1B comprises a cross-sectional view of the microphone of FIG. 1A according to various embodiments of the present invention;

FIG. 2 comprises a perspective cross-sectional view of a back plate and a diaphragm according to various embodiments of the present invention;

FIG. 3 comprises a top view of a back plate according to various embodiments of the present invention;

FIG. 4 comprises a top view of a back plate according to various embodiments of the present invention;

FIG. 5 comprises a diagram of diaphragm sensitivity level according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Approaches are described that take into account the non-uniform signal strength present on diaphragms. In particular, these approaches provide optimized back plate electrode profiles that take advantage of stronger signals from the diaphragm that are sensed by the electrode having a customized shape. Various types of profiles may be used. For example, a first back plate electrode profile can be used in a floating ring design. In another example, a star profile is used. Other shapes are possible.

In many of these embodiments, an electrode apparatus of a back plate that is used in a microelectromechanical system (MEMS) microphone is disposed in spaced proximity to a diaphragm. The electrode apparatus includes a support layer and a conductive layer arranged in proximity to the support layer, where at least one of a shape, a dimension, or a sizing of the conductive layer is matched to one or more of a sensitivity of the diaphragm, an operation of the diaphragm, or a movement of the diaphragm.

In some aspects, the support layer comprises silicon nitride. In other aspects, the conductive layer comprises poly-silicon.

In some examples, the shape comprises a star profile including a plurality of acute angle regions and a plurality of concave portions disposed between the acute angle regions. In other examples, the shape comprises a first electrode portion defining an opening therethrough, and a second electrode portion disposed within the opening, the first electrode portion being coupled to the second electrode portion by at least one connection portion.

In some aspects, the electrode apparatus includes at least one aperture disposed through the support layer and the conductive layer. In other aspects, the at least one aperture is effective to provide at least one of sound transmission, pressure relief, and pressure equalization.

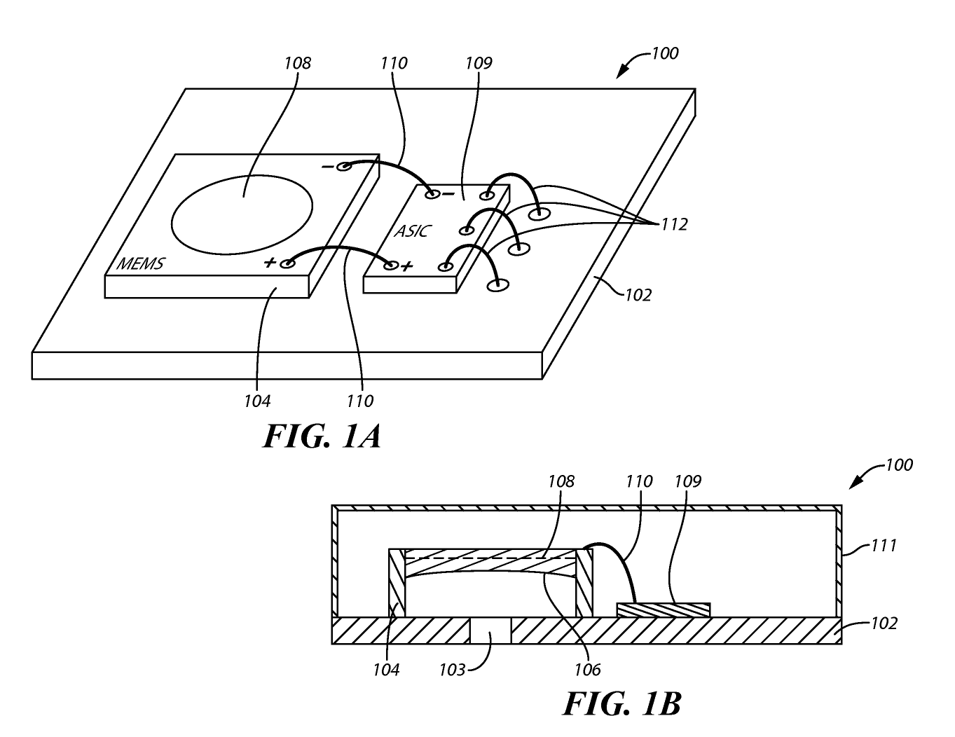

Referring now to FIG. 1A and FIG. 1B, a microelectromechanical system (MEMS) microphone 100 includes a substrate 102. The substrate 102 may be any type of base such as a printed circuit board. Other examples of substrates are possible.

Disposed on the substrate 102 is a MEMS die 104. The MEMS die 104 includes a diaphragm 106 and a back plate 108. As will be discussed in further detail below, the electrode (or conductive area) of the back plate 108 is constructed using an optimized shape or configuration that matches diaphragm movement or performance. Sound enters the microphone 100 via a port 103, which extends through the substrate 102. Alternatively, the port 103 may extend through a lid or cover 111 that covers the substrate 102 and the elements that are disposed on the substrate 102. The diaphragm 106 is a conductive plate.

The back plate 108 includes an optimized and customized electrode profiles and shapes that take into account and accommodate stronger signals from certain portions of the diaphragm (while also taking into account areas of the diaphragm that do not move or move at lower magnitude) and shapes these conductive areas (electrodes) of the back plate according to these diaphragm signal patterns. Various types of profiles may be used. For example, a first back plate electrode profile can be used in a floating ring design. A floating ring design as used herein incorporates a small primary sensing element to pickup stronger signals from diaphragm center. A typical material that may be used is doped silicon, but other examples may also be used. Focusing on stronger signals from diaphragm center results in improved sensitivity and an improved signal-to-noise ratio (SNR). The current approaches, in one aspect, also encompass a ring surrounding the sensing element. The ring may serve the role of improving RF immunity, maintaining back plate stress level, reducing likelihood of fracturing, and so forth. In another example, a star profile is used. For example, certain areas of the diaphragm have more movement (have a higher signal). The present approaches ensure these areas are sensed.

An application specific integrated circuit (ASIC) 109 is also disposed on the substrate 102. The ASIC 109 may perform various signal processing functions, to mention one example of its use. The MEMS die 104 is coupled to the ASIC 109 by wires 110. The ASIC 109 is coupled to the substrate by wires 112.

In one example of the operation of the microphone 100, sound enters the port 103 and moves the diaphragm 106. Movement of the diaphragm 106 changes the capacitance involving the back plate 108 thereby creating an electrical signal. The electrical signal may be transmitted to the ASIC 109 via wires 110. After processing of the signal by the ASIC 109, the processed signal is sent over wires 112, which couple to pads on the bottom of the substrate 102. A customer may couple other electronic devices to these pads. For example, the microphone may be disposed in a cellular phone or a personal computer and appropriate circuitry from these devices may be coupled to the pads.

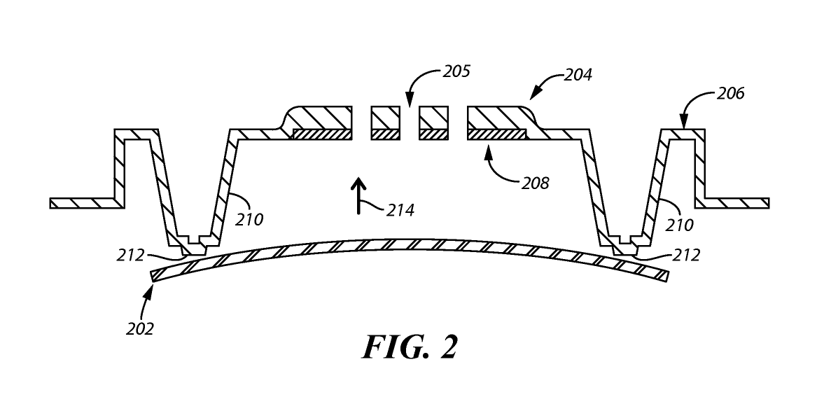

Referring now to FIG. 2, a diaphragm 202 is in close proximity to a back plate 204. The back plate 204 includes a silicon nitride layer 206. The silicon nitride layer 206 provides electrical isolation and mechanical support for the back plate 204. The back plate 204 also includes a poly-silicon layer 208. The poly-silicon layer 208 is a conductive electrode. Together, the silicon nitride layer 206 and poly-silicon layer 208 form the back plate 204. The back plate 204 is pierced by acoustic holes 205. The purpose of the acoustic holes 205 is to provide sound transmission, pressure relief, and/or pressure equalization.

The back plate also includes posts 210. The posts 210 provide support for the back plate 204. The posts 210 also provide a contact surface or area 212. As the diaphragm 202 moves in a direction indicated by the arrow labeled 214, the diaphragm 202 contacts the back plate 204 in contact surface 212.

Certain areas of the diaphragm move more than others. The present approaches ensure the electrode (conductive area) is shaped to sense these signals. The shape of the back plate can be determined by sensing movement of the diaphragm (during a testing phase) and recording the resultant movement. The shape of the conductive portion of the back plate can be made to conform to this diaphragm movement. In some aspects, certain areas of the conductive area (electrode) of the shaped back plate may be configured to sense at better levels than others. For example, the outer portions may have less sensing ability than the radially inward regions.

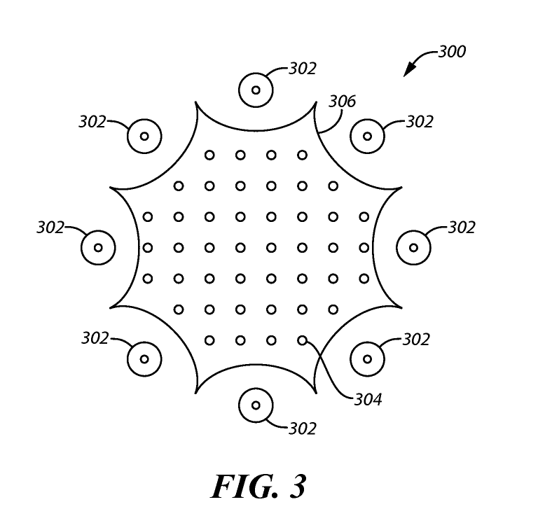

Referring now to FIG. 3, one example of a back plate 300 (and the conductive electrode area) is described. The back plate 300 includes eight posts 302 and various acoustic holes 304. In this figure, the silicon nitride layer is not shown. However, a poly-silicon layer 306 is shown. The poly-silicon layer 306 is formed in the shape of a star. This star shape improves signal pick up sensitivity. This, in turn, results in an improved (higher) signal to noise (SNR) performance and sensitivity.

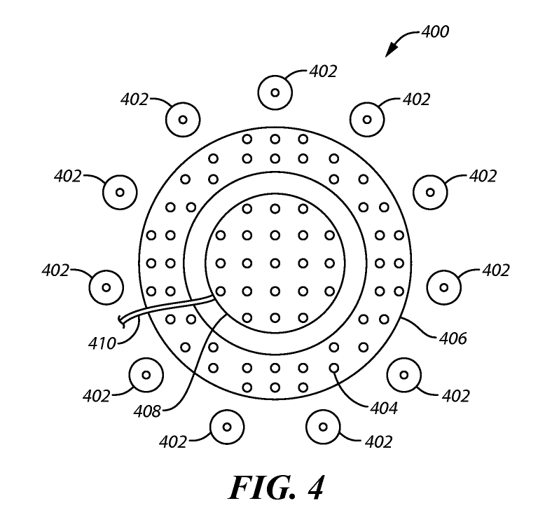

Referring now to FIG. 4, another example of a back plate 400 is described. The back plate 400 includes posts 402 and various acoustic holes 404. An outer poly-silicon ring 406 serves no performance role. An inner poly-silicon disc 408 can be altered in size and shape to modulate sensitivity. A conductive wire 410 is coupled to the inner poly-silicon disc 408. The purpose of the wire 410 is to transmit signal from sensing electrode to external modulators, such as an application specific integrated circuit (ASIC).

By “sensitivity” (and as used herein”) it is meant the ability to respond to acoustic excitations. The sensitivity modulation of the approaches described herein is also due, in some aspects to diaphragm signal and strength distribution.

The approach of FIG. 4 is a floating ring design. It is referred to a floating ring design because the sensing element is the inner circular poly-silicon. The outer ring serves no performance role in one aspect.

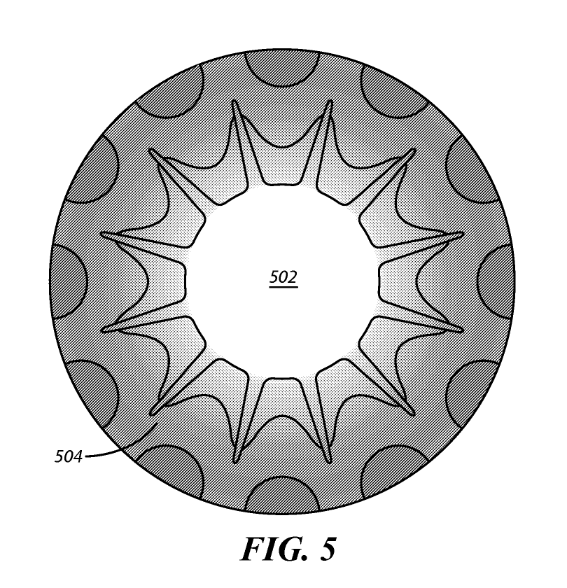

Referring now to FIG. 5, one example of diaphragm sensitivity level is shown. The lighter the shading, the stronger the signal or greater the diaphragm movement. For example, area 502 has a stronger diaphragm signal that area 504. In the approaches described herein, the poly-silicon pattern of the electrode on the back plate is designed to match this pattern on the diaphragm. This performance diagram or graph can be obtained by appropriate testing as known to those skilled in the art.

As described herein, a back plate includes a conductive layer and a support (or insulative) layer. The conductive layer is disposed underneath the support layer and is radially within the perimeter of the support layer. The shape of the conductive layer is selected so as to optimize signal sensitivity and to account for non-uniform movement of a diaphragm that functions with the back plate in an acoustic device. In other words, the shape of the conductive portion of the back plate is matched to diaphragm operation, movement, and/or sensitivity. This matching of the shape of the electrode of the back plate to the actual performance characteristics of the diaphragm results in better performance of the microphone, such as a higher sensitivity or better SNR.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. An electrode apparatus of a back plate that is used in a microelectromechanical system (MEMS) microphone, the electrode apparatus disposed in spaced proximity to a diaphragm, the electrode apparatus comprising:
a support layer;
a conductive layer arranged in proximity to the support layer;
wherein at least one of a shape, a dimension, or a sizing of the conductive layer is matched to one or more of a sensitivity of the diaphragm, an operation of the diaphragm, or a movement of the diaphragm.

2. The electrode apparatus of claim 1, wherein the support layer comprises silicon nitride.

3. The electrode apparatus of claim 1, wherein the conductive layer comprises poly-silicon.

4. The electrode apparatus of claim 1, wherein the shape comprises a star profile including a plurality of acute angle regions and a plurality of concave portions disposed between the acute angle regions.

5. The electrode apparatus of claim 1, wherein the shape comprises:
a first electrode portion defining an opening therethrough; and
a second electrode portion disposed within the opening, the first electrode portion being coupled to the second electrode portion by at least one connection portion.

6. The electrode apparatus of claim 1, further comprising at least one aperture disposed through the support layer and the conductive layer.

7. The electrode apparatus of claim 6, wherein the at least one aperture is effective to provide at least one of sound transmission, pressure relief, and pressure equalization.
